(19) United States
(12) Patent Application Publication
(10) Pub. No.: US 2024/0391497 A1
(43) Pub. Date: Nov. 28, 2024

(54) SYSTEM AND METHOD FOR VEHICLE PATH PLANNING

(71) Applicant: GM GLOBAL TECHNOLOGY OPERATIONS LLC, Detroit, MI (US)

(72) Inventors: Eran Kishon, Hod Hasharon (IL); Tzvi Philipp, Bet Shemesh (IL)

(73) Assignee: GM GLOBAL TECHNOLOGY OPERATIONS LLC, Detroit, MI (US)

(21) Appl. No.: 18/324,308

(22) Filed: May 26, 2023

(51) Int. Cl. B60W 60/00

(52) U.S. Cl. CPC B60W 60/0015; B60W 2420/403; B60W 2554/4023; B60W 2554/404

(57) ABSTRACT

A method of planning a path for a vehicle is disclosed herein. The method includes receiving a plurality of perception images. At least one perception task is detected from the plurality of perception images including identifying a neighboring vehicle. A plurality of vehicle descriptors of the neighboring vehicle is recognized, and a plurality of predetermined vehicle descriptor sets are associated with a corresponding one of a plurality of cluster values with each cluster value being associated with a risk factor. The risk factor is determined based on mapping the plurality of vehicle descriptors recognized for the neighboring vehicle onto one of the plurality of predetermined vehicle descriptor sets and assigning the risk factor associated with the cluster value to the neighboring vehicle. The path for the vehicle is planned based on the at least one perception task and the risk factor and the path is executed for the vehicle.

### INTRODUCTION

The present disclosure relates to a system and a method for path planning of autonomous vehicles.

Autonomous vehicles include sensors, such as lidar, radar, and cameras, operable to detect vehicle operation and the environment surrounding the vehicle, and a computing device operable to control aspects of vehicle operation. Autonomous vehicles generally employ a vehicle navigation system integrated with vehicle controls, drive-by-wire systems, vehicle-to-vehicle communication, and/or vehicle-to-infrastructure technology to identify vehicle position and navigate the vehicle.

Typically, a vehicle navigation system uses a global positioning system (GPS) system to obtain its position data, which is then correlated to the vehicle's position relative to a surrounding geographical area. Based on the GPS signal, when directions to a specific waypoint are needed, routing to such a destination may be calculated, thereby determining a vehicle path. Specifically, the vehicle sensors and the computing device may cooperate to identify intermediate way points and maneuver the vehicle between such way points to maintain the vehicle on the selected path.

While maneuvering the autonomous vehicle along a selected path, the vehicle may encounter a number of other vehicles, such as non-autonomously operated vehicles, along the roadway. Other vehicles, such as non-autonomously operated vehicles, may not follow traffic laws and practices.

### SUMMARY

A method of planning a path for a vehicle is disclosed herein. The method includes receiving a plurality of perception images of an area surrounding the vehicle with at least one sensor. At least one perception task is detected from the plurality of perception images with the at least one perception task including identifying a neighboring vehicle. A plurality of vehicle descriptors of the neighboring vehicle in the plurality of perception images are recognized and a plurality of predetermined vehicle descriptor sets are associated with a corresponding one of a plurality of cluster values with each of the plurality of cluster values being associated with a risk factor. The risk factor for the neighboring vehicle is determined based on mapping the plurality of vehicle descriptors recognized for the neighboring vehicle onto one of the plurality of predetermined vehicle descriptor sets and assigning the risk factor associated with the cluster value to the neighboring vehicle. The path for the vehicle is planned based on the at least one perception task and the risk factor and the path is executed for the vehicle.

Another aspect of disclosure may be a method where the neighboring vehicle includes at least one of a heavy-duty vehicle, a light-duty vehicle, a sports car, a luxury car, a sport utility vehicle, a family car, or a motorcycle.

Another aspect of the disclosure may be a method where the plurality of vehicle descriptors includes at least two of a vehicle brand, a vehicle model, or a vehicle age range.

Another aspect of the disclosure may be a method where each of the plurality of cluster values are determined from at least one insurance risk score corresponding to one of the plurality of vehicle descriptor sets.

Another aspect of the disclosure may be a method where the at least one insurance risk score is determined from at least one insurance database having vehicle risk scores associated with the each of the plurality of predetermined vehicle descriptor sets.

Another aspect of the disclosure may be a method where the at least one insurance risk score includes a plurality of insurance risk scores and each of the plurality of cluster values is calculated by a weighted average of the plurality of insurance risk scores.

Another aspect of the disclosure may be a method where each of the plurality of cluster values are determined from at least one report risk score corresponding to one of the plurality of vehicle descriptor sets.

Another aspect of the disclosure may be a method where the at least one report risk score includes at least one of a vehicle report or a police report relating to the vehicle type of the at least one neighboring vehicle.

Another aspect of the disclosure may be a method where each of the plurality of cluster values are determined from a plurality of insurance risk scores and at least one report risk score corresponding to one of the plurality of vehicle descriptor sets.

Another aspect of the disclosure may be a method where each of the plurality of cluster values are calculated by a weighted average of the plurality of insurance risk scores and the at least one report risk score.

Another aspect of the disclosure may be a method where associating a plurality of predetermined vehicle descriptor sets with a corresponding one of a plurality of cluster values includes generating a statistics table with each of the plurality of predetermined vehicle descriptor sets identified with each of the plurality of cluster values and the risk factor associated with the cluster value.

Another aspect of the disclosure may be a method where the vehicle is an autonomous motor vehicle.

Another aspect of the disclosure may be a method where the at least one sensor includes at least one camera.

A non-transitory computer-readable storage medium embodying programmed instructions which, when executed by a processor, are operable for performing a method is disclosed herein. The method includes receiving a plurality of perception images of an area surrounding a vehicle with at least one sensor. At least one perception task is detected from the plurality of perception images with the at least one perception task including identifying a neighboring vehicle. A plurality of vehicle descriptors of the neighboring vehicle in the plurality of perception images are recognized and a plurality of predetermined vehicle descriptor sets are associated with a corresponding one of a plurality of cluster values with each of the plurality of cluster values being associated with a risk factor. The risk factor for the neighboring vehicle is determined based on mapping the plurality of vehicle descriptors recognized for the neighboring vehicle onto one of the plurality of predetermined vehicle descriptor sets and assigning the risk factor associated with the cluster value to the neighboring vehicle. The path for the vehicle is planned based on the at least one perception task and the risk factor and the path is executed for the vehicle.

A vehicle system is disclosed herein. The vehicle system includes a drivetrain, a power source in communication with the drivetrain, a plurality of sensors, and a controller in communication with the plurality of sensors. The controller is configured to receive a plurality of perception images of an area surrounding a vehicle with at least one sensor and detect at least one perception task from the plurality of perception images, wherein the at least one perception task includes identifying a neighboring vehicle. The controller is also configured to recognize a plurality of vehicle descriptors of the neighboring vehicle in the plurality of perception images and associate a plurality of predetermined vehicle descriptor sets with a corresponding one of a plurality of cluster values, wherein each of the plurality of cluster values is associated with a risk factor. The controller is further configured to determine a risk factor for the neighboring vehicle based on mapping the plurality of vehicle descriptors recognized for the neighboring vehicle onto one of the plurality of predetermined vehicle descriptor sets and assigning the risk factor associated with the cluster value to the neighboring vehicle. The controller is further configured to plan a path for the vehicle based on the at least one perception task and the risk factor and execute the path for the vehicle.

### BRIEF DESCRIPTION OF THE DRAWINGS

FIG. 1 is a schematic illustration of an example autonomous motor vehicle.

FIG. 2 illustrates an example method of planning a path for the motor vehicle in FIG. 1.

FIG. 3 schematically illustrates the autonomous motor vehicle on a roadway surrounded by a plurality of neighboring vehicles.

FIG. 4 illustrates an example risk prediction table.

The present disclosure may be modified or embodied in alternative forms, with representative embodiments shown in the drawings and described in detail below. The present disclosure is not limited to the disclosed embodiments. Rather, the present disclosure is intended to cover alternatives falling within the scope of the disclosure as defined by the appended claims.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

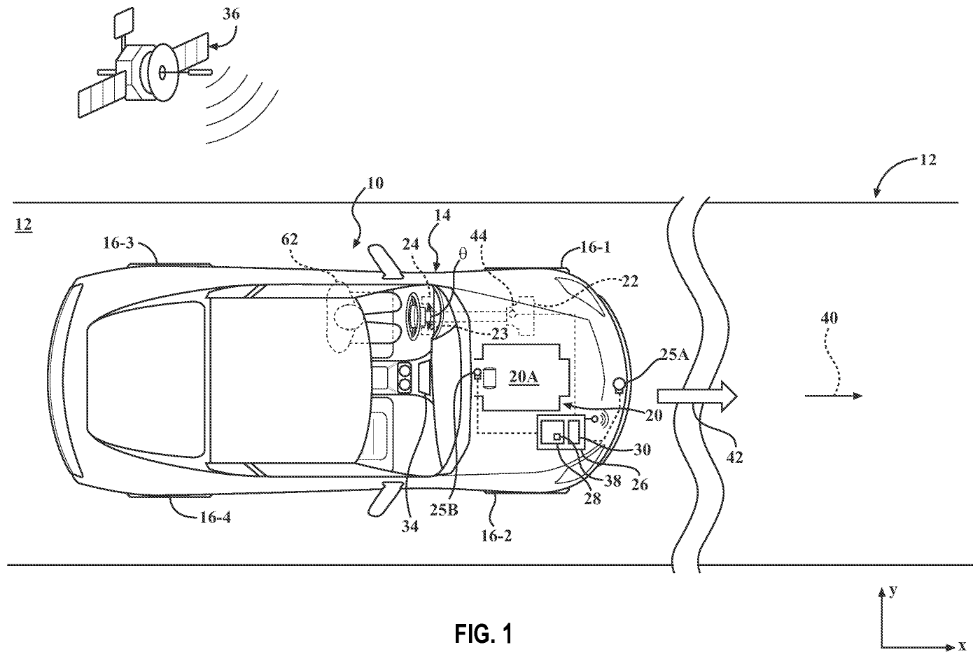

Referring to the FIGS., wherein like numerals indicate like parts referring to the drawings, wherein like reference numbers refer to like components, FIG. 1 shows a schematic view of a motor vehicle 10 positioned relative to a road surface, such as a vehicle lane 12. As shown in FIG. 1, the vehicle 10 includes a vehicle body 14, a first axle having a first set of road wheels 16-1, 16-2, and a second axle having a second set of road wheels 16-3, 16-4 (such as individual left-side and right-side wheels on each axle). Each of the road wheels 16-1, 16-2, 16-3, 16-4 employs tires configured to provide fictional contact with the vehicle lane 12. Although two axles, with the respective road wheels 16-1, 16-2, 16-3, 16-4, are specifically shown, nothing precludes the motor vehicle 10 from having additional axles.

As shown in FIG. 1, a vehicle suspension system operatively connects the vehicle body 14 to the respective sets of road wheels 16-1, 16-2, 16-3, 16-4 for maintaining contact between the wheels and the vehicle lane 12, and for maintaining handling of the motor vehicle 10. The motor vehicle 10 additionally includes a drivetrain 20 having a power-source or multiple power-sources 20A, which may be an internal combustion engine (ICE), an electric motor, or a combination of such devices, configured to transmit a drive torque to the road wheels 16-1, 16-2 and/or the road wheels 16-3, 16-4. The motor vehicle 10 also employs vehicle operating or control systems, including devices such as one or more steering actuators 22 (for example, an electrical power steering unit) configured to steer the road wheels 16-1, 16-2, a steering angle (θ), an accelerator device 23 for controlling power output of the power-source(s) 20A, a braking switch or device 24 for retarding rotation of the road wheels 16-1 and 16-2 (such as via individual friction brakes located at respective road wheels), etc.

As shown in FIG. 1, the motor vehicle 10 includes at least one sensor 25A and an electronic controller 26 that cooperate to at least partially control, guide, and maneuver the vehicle 10 in an autonomous mode during certain situations. As such, the vehicle 10 may be referred to as an autonomous vehicle. To enable efficient and reliable autonomous vehicle control, the electronic controller 26 may be in operative communication with the steering actuator(s) 22 configured as an electrical power steering unit, accelerator device 23, and braking device 24. The sensors 25A of the motor vehicle 10 are operable to sense the vehicle lane 12 and monitor a surrounding geographical area and traffic conditions proximate the motor vehicle 10.

The sensors 25A of the vehicle 10 may include, but are not limited to, at least one of a Light Detection and Ranging (LIDAR) sensor, radar, and camera located around the vehicle 10 to detect the boundary indicators, such as edge conditions, of the vehicle lane 12. The type of sensors 25A, their location on the vehicle 10, and their operation for detecting and/or sensing the boundary indicators of the vehicle lane 12 and monitor the surrounding geographical area and traffic conditions are understood by those skilled in the art, are not pertinent to the teachings of this disclosure, and are therefore not described in detail herein. The vehicle 10 may additionally include sensors 25B attached to the vehicle body and/or drivetrain 20.

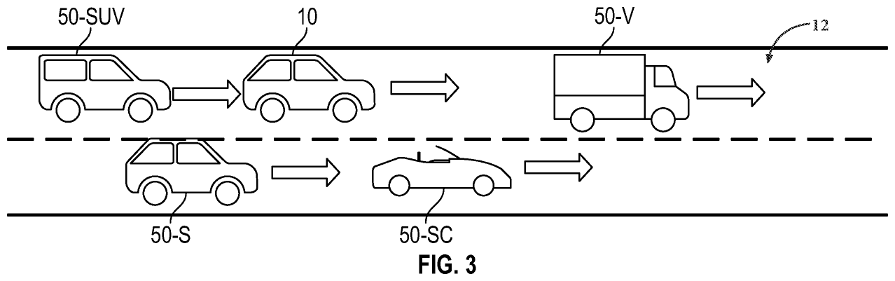

The electronic controller 26 is disposed in communication with the sensors 25A of the vehicle 10 for receiving their respective sensed data related to the detection or sensing of the vehicle lane 12 and monitoring of the surrounding geographical area and traffic conditions. The electronic controller 26 may alternatively be referred to as a control module, a control unit, a controller, a vehicle 10 controller, a computer, etc. The electronic controller 26 may include a computer and/or processor 28, and include software, hardware, memory, algorithms, connections (such as to sensors 25A and 25B), etc., for managing and controlling the operation of the vehicle 10. As such, a method, described below and generally represented in FIG. 3, may be embodied as a program or algorithm partially operable on the electronic controller 26. It should be appreciated that the electronic controller 26 may include a device capable of analyzing data from the sensors 25A and 25B, comparing data, making the decisions required to control the operation of the vehicle 10, and executing the required tasks to control the operation of the vehicle 10.

The electronic controller 26 may be embodied as one or multiple digital computers or host machines each having one or more processors 28, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and input/output (I/O) circuitry, I/O devices, and communication interfaces, as well as signal conditioning and buffer electronics. The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random-access memory (DRAM), which may constitute a main memory. Other examples of embodiments for memory include a flexible disk, hard disk, magnetic tape or other magnetic medium, a CD-ROM, DVD, and/or other optical medium, as well as other possible memory devices such as flash memory.

The electronic controller 26 includes a tangible, non-transitory memory 30 on which computer-executable instructions, including one or more algorithms, are recorded for regulating operation of the motor vehicle 10. The subject algorithm(s) may specifically include an algorithm configured to monitor localization of the motor vehicle 10 and determine the vehicle's heading relative to a mapped vehicle trajectory on a particular road course to be described in detail below.

The motor vehicle 10 also includes a vehicle navigation system 34, which may be part of integrated vehicle controls, or an add-on apparatus used to find travel direction in the vehicle. The vehicle navigation system 34 is also operatively connected to a global positioning system (GPS) 36 using an earth orbiting satellite. The vehicle navigation system 34 in connection with the GPS 36 and the above-mentioned sensors 25A may be used for automation of the vehicle 10. The electronic controller 26 is in communication with the GPS 36 via the vehicle navigation system 34. The vehicle navigation system 34 uses a satellite navigation device (not shown) to receive its position data from the GPS 36, which is then correlated to the vehicle's position relative to the surrounding geographical area. Based on such information, when directions to a specific waypoint are needed, routing to such a destination may be mapped and calculated. On-the-fly terrain and/or traffic information may be used to adjust the route. The current position of a vehicle 10 may be calculated via dead reckoning—by using a previously determined position and advancing that position based upon given or estimated speeds over elapsed time and course by way of discrete control points.

The electronic controller 26 is generally configured, i.e., programmed, to determine or identify localization 38 (current position in the X-Y plane, shown in FIG. 1), velocity, acceleration, yaw rate, as well as intended path 40, and heading 42 of the motor vehicle 10 on the vehicle lane 12. The localization 38, intended path 40, and heading 42 of the motor vehicle 10 may be determined via the navigation system 34 receiving data from the GPS 36, while velocity, acceleration (including longitudinal and lateral g's), and yaw rate may be determined from vehicle sensors 25B. Alternatively, the electronic controller 26 may use other systems or detection sources arranged remotely with respect to the vehicle 10, for example a camera, to determine localization 38 of the vehicle relative to the vehicle lane 12.

As noted above, the motor vehicle 10 may be configured to operate in an autonomous mode guided by the electronic controller 26. In such a mode, the electronic controller 26 may further obtain data from vehicle sensors 25B to guide the vehicle along the desired path, such as via regulating the steering actuator 22. The electronic controller 26 may be additionally programmed to detect and monitor the steering angle (θ) of the steering actuator(s) 22 along the desired path 40, such as during a negotiated turn. Specifically, the electronic controller 26 may be programmed to determine the steering angle (θ) via receiving and processing data signals from a steering position sensor 44 (shown in FIG. 1) in communication with the steering actuator(s) 22, accelerator device 23, and braking device 24.

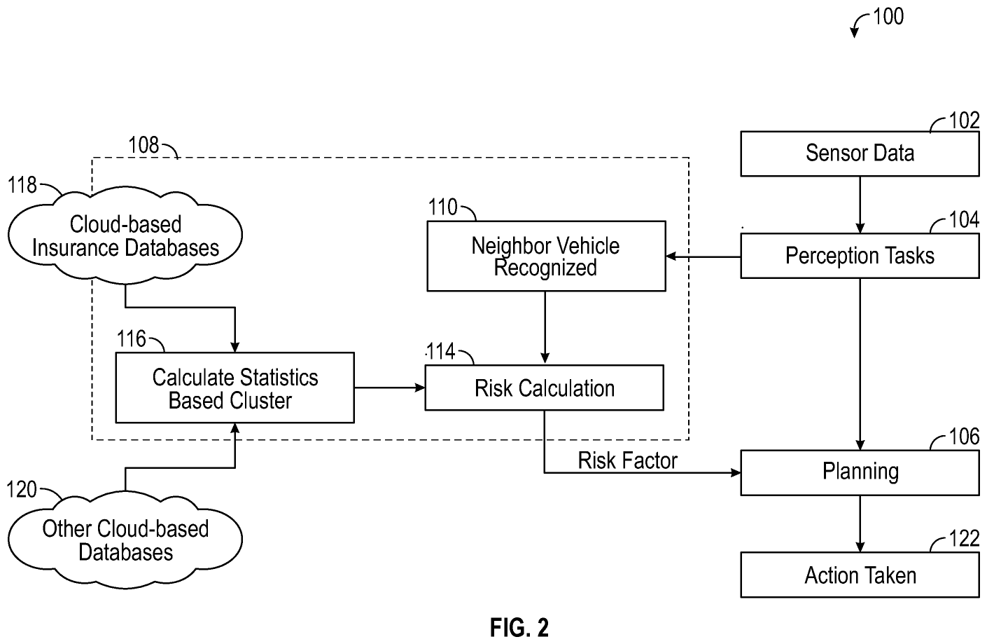

FIG. 2 illustrates an example method 100 of planning a path for the motor vehicle 10. The method 100 provides additional inputs when planning the path for the motor vehicle similar to how human drivers 62 plan their immediate driving maneuvers through awareness of the instantaneous surroundings. The method 100 receives sensor data from at least one of the sensors 25A, 25B on the motor vehicle 10 at Block 102. In one example, the sensor data includes a plurality of perceptions images of an area surrounding the motor vehicle 10. The at least one sensor 25A, 25B can provide at least one of a forward field of view, lateral side fields of view, or a rear field of view around the motor vehicle 10. Furthermore, the at least one sensor 25A, 25B can include cameras with overlapping fields of view for identifying the neighboring vehicles 50 surrounding the vehicle 10. In the illustrated example of FIG. 3, the motor vehicle 10 is located on a vehicle lane 12 surrounded by several neighboring vehicles 50, such as a van 50-V, a sports car 50-SC, a SUV 50-SUV, and a sedan 50-S. In the illustrated example, the vehicles 50 are identified as neighboring vehicles 50 when they are within a predetermined distance from the motor vehicle 10. In one example, the predetermined distance is less than five lengths of the motor vehicle 10 and in another example, the predetermined distance is less than ten lengths of the motor vehicle 10.

The method 100 evaluates at least one perception task (Block 104) from the sensor data received from Block 102, such as camera images captured by the cameras. The perception tasks can include detecting neighboring vehicles, pedestrians, obstacles, vehicle lanes 12, or other path attributes used when planning the vehicle path to a destination. The perception tasks from Block 104 provide one source of information for planning the path of the motor vehicle 10 at Block 106. In addition to utilizing the perception tasks for planning the path of the motor vehicle 10 at Block 106, the method 100 calculates a risk factor (Block 108) for each of the neighboring vehicles 50 based on statistical information regarding the neighboring vehicles 50.

The method 100 calculates the risk factor for each of the neighboring vehicles based on a combination of information received from the sensor data (Block 102) and statistical data received by Block 108. To calculate and assign the risk factor to each of the neighboring vehicles 50, the method 100 utilizes the plurality of perception images to recognize the neighboring vehicle 50 at Block 110. When recognizing the neighboring vehicle 50, Block 110 determines vehicle descriptors, such as a vehicle brand (V-B), a vehicle model (V-M), and a vehicle age range (V-A). In the illustrated example, the vehicle age range is characterized by a range of years, such as 0-5 years old, 5-15 years old, and greater than 15 years old.

In one embodiment, the Block 110 can identify the vehicle descriptors for the neighboring vehicle 50 through the use of a neural network trained to identify the vehicle brand, the vehicle model, and the vehicle age range. The neural network can use the perceptions images from Block 104 that have already identified a region in the image with a vehicle as an input into the neural network for recognition of the vehicle descriptors. In this disclosure, the vehicles could include heavy-duty vehicles, light-duty vehicles, sports cars, luxury cars, sport utility vehicles, family cars, or motorcycles. The vehicle descriptors determined by Block 110 are then provided to Block 114 for performing a risk calculation.

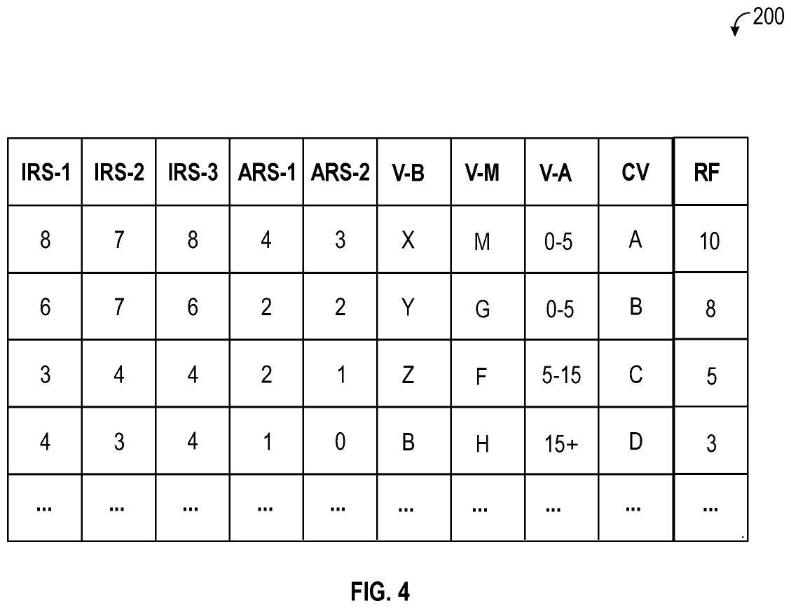

The method 100 maintains a statistics table 200 (FIG. 4) at Block 116. In the illustrated example, the statistics table 200 includes a plurality of insurance risk scores, such as a first insurance risk score (IRS-1), a second insurance risk score (IRS-2), and a third insurance risk score (IRS-3). The plurality of insurance risk scores in each row are associated with a plurality of predetermined vehicle descriptor sets (V-B, V-M, or V-A) corresponding to a possible neighboring vehicle. However, there may be some rows for vehicle descriptors in the statistics table 200 with a single insurance risk score. In the illustrated example, the insurance risk scores are on a scale of 1-10 with 10 indicating the highest risk score and 1 indicating the lowest risk score.

The statistics table 200 can also include additional statistical information from other sources that can be used to calculate the cluster value (CV) at Block 116 for each set of the vehicle descriptors. In one example, police reports including statistical information regarding the types of vehicles most likely to speed or be involved in traffic violations for a given geographical location could be used to provide an additional risk score (ARS-1). Furthermore, additional statistical information sources, such as vehicle reports, could be collected to provide another additional risk source (ARS-2) that could be associated with a corresponding set of vehicle descriptors. In the illustrated example, the statistical information provided by the additional data sources is measured on a scale of 0-5. However, other scales could be used for the additional risk scores or the insurance risk scores.

The method 100 weighs the insurance risk scores and the additional risk scores to assign the cluster value (CV) to each of the vehicle descriptors in the rows of the statistics table 200. The cluster value for each row could be determined by a weighted average between the insurance risk scores and the additional risk scores with weights being determined based on database reliability or confidence. For example, a database with a larger sampling size could be given a greater weight than a risk score determined from a database with a smaller sampling size.

In the illustrated example, the insurance risk scores (IRS) can be obtained from a cloud-based insurance statistical database (Block 118) from multiple insurance sources and the additional risk scores could be obtained from another cloud-based database (Block 120). The databases from Blocks 118 and 120 can be updated at regular intervals as the databases are updated to include more information, such as information regarding new vehicle makes and models associated with new vehicle descriptors. This allows the statistics table 200 from Block 116 to be updated periodically as the source data changes or information regarding new vehicle descriptors becomes available.

The Block 116 can output at least the columns from the statistics table 200 identifying the vehicle descriptors (V-B, V-M, V-A), cluster value (CV), and associated risk factor (RF) based on the cluster value to the Block 114 for performing the risk calculation. In the illustrated example, 10 represents the highest risk factor and 0 represents the lowest risk factor.

The risk calculation at Block 114 is performed by associating the vehicle descriptors received from Block 110 for the neighboring vehicle 50 with a corresponding row in the statistics table 200 matching the vehicle descriptors. The risk factor from that row of the statistics table 200 is them provided to Block 106 for planning the vehicle path based on the risk factor associated with the neighboring vehicle 50 is addition to the perceptions tasks. With the path planned, the method 100 takes action at Block 122 to execute the planned path.

In some situations, a perfect match between the vehicle descriptors identified by Block 110 and the vehicle descriptors in the statistics table 200 may not be reached. For example, the Block 110 may determine just two of the three vehicle descriptors with a predetermined level of confidence. In these situations, the risk calculation will determine if there are variations in cluster value assigned based on the at least two vehicle descriptors. If there are not variations in cluster values assigned to the rows matching the two determined vehicle descriptors, then the risk calculation will use the cluster value that is common among the determined vehicle descriptors. Alternatively, if there are variations in the cluster value among the two determined vehicle descriptors, the risk calculation can use an average risk factor associated with the cluster values for the two determined vehicle descriptors.

Once the method 100 has planned the path, the method 100 can then execute the path for the motor vehicle 10 at Block 116. The method 100 can be continuously performed for each of the neighboring vehicles identified from the perception images to update the path planned for the motor vehicle 10.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of planning a path for a vehicle, the method comprising:
receiving a plurality of perception images of an area surrounding the vehicle with at least one sensor;
detecting at least one perception task from the plurality of perception images, wherein the at least one perception task includes identifying a neighboring vehicle;
recognizing a plurality of vehicle descriptors of the neighboring vehicle in the plurality of perception images;
associating a plurality of predetermined vehicle descriptor sets with a corresponding one of a plurality of cluster values, wherein each of the plurality of cluster values is associated with a risk factor;
determining a risk factor for the neighboring vehicle based on mapping the plurality of vehicle descriptors recognized for the neighboring vehicle onto one of the plurality of predetermined vehicle descriptor sets and assigning the risk factor associated with the cluster value to the neighboring vehicle;
planning the path for the vehicle based on the at least one perception task and the risk factor; and
executing the path for the vehicle.

2. The method of claim 1, wherein the neighboring vehicle includes at least one of a heavy-duty vehicle, a light-duty vehicle, a sports car, a luxury car, a sport utility vehicle, a family car, or a motorcycle.

3. The method of claim 1, wherein the plurality of vehicle descriptors includes at least two of a vehicle brand, a vehicle model, or a vehicle age range.

4. The method of claim 1, wherein each of the plurality of cluster values are determined from at least one insurance risk score corresponding to one of the plurality of vehicle descriptor sets.

5. The method of claim 4, wherein the at least one insurance risk score is determined from at least one insurance database having vehicle risk scores associated with the each of the plurality of predetermined vehicle descriptor sets.

6. The method of claim 4, wherein the at least one insurance risk score includes a plurality of insurance risk scores and each of the plurality of cluster values is calculated by a weighted average of the plurality of insurance risk scores.

7. The method of claim 4, wherein each of the plurality of cluster values are determined from at least one report risk score corresponding to one of the plurality of vehicle descriptor sets.

8. The method of claim 7, wherein the at least one report risk score includes at least one of a vehicle report or a police report relating to the vehicle type of the at least one neighboring vehicle.

9. The method of claim 1, wherein each of the plurality of cluster values are determined from a plurality of insurance risk scores and at least one report risk score corresponding to one of the plurality of vehicle descriptor sets.

10. The method of claim 9, wherein each of the plurality of cluster values are calculated by a weighted average of the plurality of insurance risk scores and the at least one report risk score.

11. The method of claim 1, wherein associating a plurality of predetermined vehicle descriptor sets with a corresponding one of a plurality of cluster values includes generating a statistics table with each of the plurality of predetermined vehicle descriptor sets identified with each of the plurality of cluster values and the risk factor associated with the cluster value.

12. The method of claim 1, wherein the vehicle is an autonomous motor vehicle.

13. The method of claim 1, wherein the at least one sensor includes at least one camera.

14. A non-transitory computer-readable storage medium embodying programmed instructions which, when executed by a processor, are operable for performing a method comprising:
receiving a plurality of perception images of an area surrounding a vehicle with at least one sensor;
detecting at least one perception task from the plurality of perception images, wherein the at least one perception task includes identifying a neighboring vehicle;
recognizing a plurality of vehicle descriptors of the neighboring vehicle in the plurality of perception images;
associating a plurality of predetermined vehicle descriptor sets with a corresponding one of a plurality of cluster values, wherein each of the plurality of cluster values is associated with a risk factor;
determining a risk factor for the neighboring vehicle based on mapping the plurality of vehicle descriptors recognized for the neighboring vehicle onto one of the plurality of predetermined vehicle descriptor sets and assigning the risk factor associated with the cluster value to the neighboring vehicle;
planning a path for the vehicle based on the at least one perception task and the risk factor; and
executing the path for the vehicle.

15. The storage medium of claim 14, wherein the vehicle is an autonomous motor vehicle and the at least one sensor includes at least one camera.

16. The storage medium of claim 14, wherein the vehicle type includes at least one of a heavy-duty vehicle, a light-duty vehicle, a sports car, a luxury car, a sport utility vehicle, a family car, or a motorcycle.

17. The storage medium of claim 14, wherein each of the plurality of cluster values are determined from at least one insurance risk score corresponding to one of the plurality of vehicle descriptor sets.

18. The storage medium of claim 17, wherein the plurality of vehicle descriptors includes at least two of a vehicle brand, a vehicle model, or a vehicle age range.

19. The storage medium of claim 14, wherein associating a plurality of predetermined vehicle descriptor sets with a corresponding one of a plurality of cluster values includes generating a statistics table with each of the plurality of predetermined vehicle descriptor sets identified with each of the plurality of cluster values and the risk factor associated with the cluster value.

20. A vehicle system comprising:
a drivetrain;
a power source in communication with the drivetrain;
a plurality of sensors:
a controller in communication with the plurality of sensors and configured to:
receive a plurality of perception images of an area surrounding a vehicle with at least one sensor;
detect at least one perception task from the plurality of perception images, wherein the at least one perception task includes identifying a neighboring vehicle;
recognize a plurality of vehicle descriptors of the neighboring vehicle in the plurality of perception images;
associate a plurality of predetermined vehicle descriptor sets with a corresponding one of a plurality of cluster values, wherein each of the plurality of cluster values is associated with a risk factor;
determine a risk factor for the neighboring vehicle based on mapping the plurality of vehicle descriptors recognized for the neighboring vehicle onto one of the plurality of predetermined vehicle descriptor sets and assigning the risk factor associated with the cluster value to the neighboring vehicle;
plan a path for the vehicle based on the at least one perception task and the risk factor; and
execute the path for the vehicle.
